(19) United States
(12) Patent Application Publication
(10) Pub. No.: US 2025/0384583 A1
(43) Pub. Date: Dec. 18, 2025

(54) MODELING GRAPH-STRUCTURED DATA WITH POINT GRID CONVOLUTION

(71) Applicant: INTEL CORPORATION, Santa Clara, CA (US)

(72) Inventors: Anbang Yao, Beijing (CN); Yangyuxuan Kang, Beijing (CN); Shandong Wang, Beijing (CN); Zhou Wang, Beijing (CN); Zhen Zhao, Shanghai (CN); Yurong Chen, Beijing (CN)

(21) Appl. No.: 18/857,053

(22) PCT Filed: May 16, 2022
(86) PCT No.: PCT/CN2022/093138

§ 371 Date: Oct. 15, 2024

(51) Int. Cl. G06T 7/73; G06T 17/00

(52) U.S. Cl. CPC G06T 7/75; G06T 17/00; G06T 2207/20072; G06T 2207/20081; G06T 2207/20084

(57) ABSTRACT

A graphical representation of an object (e.g., a 2D image) is transformed to a grid representation of the object. The grid representation adopts a structure of a grid. Graph nodes are extracted from the graphical representation and arranged based on the structure. An anchor node may be selected from the graph nodes and assigned to an element of the grid. Other graph nodes can be assigned to other elements of the grid based on their relationships with the anchor node. The grid representation can be processed by a CNN including one or more convolutional layers. A convolutional layer may receive the grid representation, generates variants of the grid representations, and extract features based on the variants. The output of the CNN can be used to determine a condition of the object, e.g., to generate a 3D graphical representation of the object that shows a pose of the object.

### TECHNICAL FIELD

This disclosure relates generally to deep neural networks (DNNs), and more specifically, to modeling graph-structured data with point grid convolution.

### BACKGROUND

DNNs are used extensively for a variety of artificial intelligence (AI) applications ranging from computer vision to speech recognition and natural language processing due to their ability to achieve high accuracy. One type of DNN is graph convolutional network (GCN). GCN is one of the prevailing solutions for various AI applications, such as human pose lifting, skeleton based human action recognition, mesh reconstruction, traffic navigation, social network analysis, recommend system, scientific computing, and so on.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example layer structure of a CNN, in accordance with various embodiments.

FIG. 2 is a block diagram of a point grid system, in accordance with various embodiments.

FIG. 3 illustrates an example point grid convolution, in accordance with various embodiments.

FIGS. 4A-4C illustrates an example semantic grid transformation, in accordance with various embodiments.

FIG. 5 illustrates an example three-dimensional (3D) pose estimation based on a two-dimensional (2D) image, in accordance with various embodiments.

FIG. 6 illustrates an example grid lifting network, in accordance with various embodiments.

FIG. 7 illustrates an example point grid layer including multiple branches, in accordance with various embodiments.

FIG. 8 illustrates a deep learning (DL) environment, in accordance with various embodiments.

FIG. 9 is a flowchart showing a method of modeling graph-structured data with point grid convolution, in accordance with various embodiments.

FIG. 10 is a block diagram of an example computing device, in accordance with various embodiments.

### DETAILED DESCRIPTION

### Overview

GCNs are a variant of convolutional neural networks (CNNs). GCNs are adopted to operate on data samples represented in the form of irregular graphic structures, such as images. Taking pose lifting network for example, pose lifting network is a specific type of GCN. A pose lifting network is usually trained to estimate 3D human pose given locations of body joints detected from a 2D input. Estimating 3D human pose from images and videos has a wide range of applications such as human action recognition, human robot/computer interaction, augmented reality, animation and gaming. Generally, existing pose lifting networks can be grouped into four solution families: (1) Fully Connected Network (FCN); (2) Semantic Graph Convolution Network (SGCN); (3) Locally Connected Network (LCN); and (4) other variants of FCN, SGCN and LCN. All these pose lifting networks operate based on data samples represented in the form of irregular graph structures.

However, the usage of such data samples can limit the performance of GCNs in certain image-based applications. Also, it can lead to irregular workloads, e.g., irregular sparse tensor operations. These irregular workloads prevent GCNs from being efficiently executed on many AI processors, such as GPUs (graphics processing units), CPUs (central processing units), VPUs (vision processing units), TPUs (tensor processing units), and so on. Therefore, improved techniques for convolutional operations on graph-structured data are needed.

Embodiments of the present disclosure may improve on at least some of the challenges and issues described above by providing methods and apparatus that facilitate modeling graph-structured data with point grid convolution. In various embodiments of the present disclosure, graph-structured data is converted to data with regular structures, e.g., grid-structured data, so that the data can be run with more efficient CNNs. For instance, a graphical representation (e.g., an image) of an object (e.g., a person, animal, plant, tree, building, etc.) is transformed to a grid representation of the object. The transformation is referred to as sematic grid transformation. The grid may have a regular structure, such as a structure including a number of rows, where a row includes one or more elements. The structure of the grid is adopted by the grid representation through the semantic grid transformation. With the structure of the grid, the grid representation of the object can be processed through convolutional operations that can be more efficient than conventional graph convolutional operations. A convolution on grid-structured data is referred to as a point grid convolution or grid convolution. A convolutional neural network that processes grid-structured data is referred to as a point grid network or point grid model.

In some embodiments, the sematic grid transformation includes extraction of graph nodes from the graphical representation of the object. A graph node may represent a component of an object shown in the image. The graph nodes are assigned to different elements of the grid. In some embodiments, an anchor node is selected (e.g., randomly or based on a rule from some or all the graph nodes and is assigned first. In an example, a root node is selected as the anchor node, e.g., to facilitate preservation of relationships (e.g., connections) between the graph nodes in the graphical representation. The anchor node may be assigned to a pre-determined element of the grid, e.g., the first row of the grid. The other graph nodes can be assigned based on the anchor node. For instance, a relationship between a graph node and the anchor node is determined and the graph node is assigned to an element based on the relationship and the pre-determined element. The relationship may be determined based on a distance between the component represented by the graph node ad the component represented by the anchor node in the image. In an embodiment, a hierarchy of the graph nodes other than the anchor node may be determined. For instance, these graph nodes are divided into tiers (“node tiers”) based on their relationships with the anchor node. The elements of the grid may also be divided into tiers (“element tiers”) based on their relationship with the pre-determined element. A node tier may be assigned to an element tier so that the graph nodes in the node tier are assigned to the elements in the element tier.

Through the sematic grid transformation, the intrinsic relationships between the graph nodes are preserved. Also, data samples with irregular graphic structures are converted to data samples with regular grid structures. That way, the point grid convolution can have the merits of regular convolutions in CNNs and have better accuracy and efficiency than conventional GCNs. Point grid networks can be used to solve various AI problems. For instance, a point grid network can determine a condition of an object. Examples of the condition include a classification, a pose, an action, a mood, an orientation, an interest, a traffic-related condition, other types of conditions, or some combination thereof. The condition may be used in various applications, such as human pose lifting, skeleton based human action recognition, 3D mesh reconstruction, traffic navigation, social network analysis, recommend system, scientific computing, and so on. An example point grid network is a pose lifting network that processes a grid transformed from a 2D image and outputs features that can be transformed to a 3D image showing a pose of the object.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The DNN systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example CNN Layer Structure

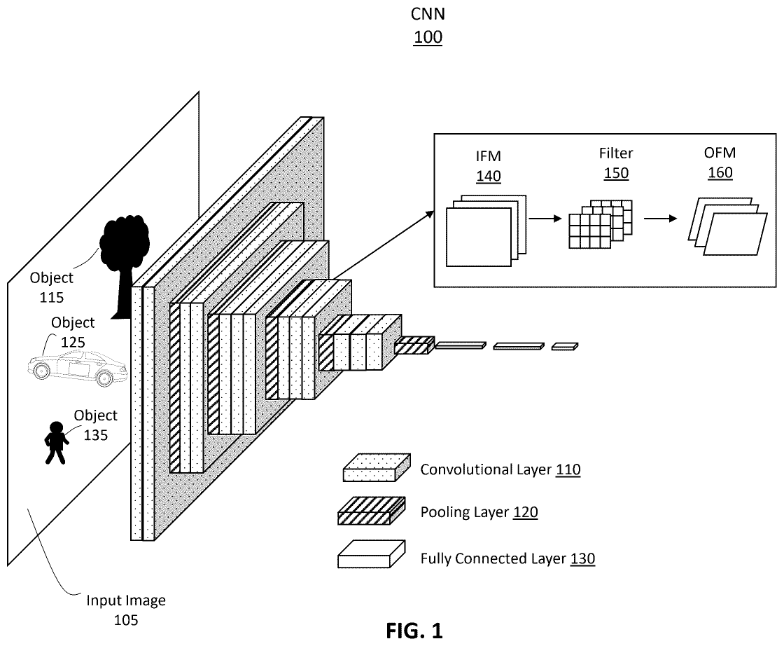

FIG. 1 illustrates an example layer structure of a CNN 100, in accordance with various embodiments. For purpose of illustration, the CNN 100 is trained to receive images and output classifications of objects in the images. In the embodiment of FIG. 1, the CNN 100 receives an input image 105 that includes objects 115, 125, and 135. The CNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the CNN 100 may include fewer, more, or different layers.

The convolutional layers 110 summarize the presence of features in the input image 105. In the embodiment of FIG. 1, the first layer of the CNN 100 is a convolutional layer 110. The convolutional layers 110 function as feature extractors. A convolutional layer 110 can receive an input and outputs features extracted from the input. In an example, a convolutional layer 110 performs a convolution to an IFM (input feature map) 140 by using a filter 150, generates an OFM (output feature map) 160 from the convolution, and passes the OFM 160 to the next layer in the sequence. The IFM 140 may include a plurality of IFM matrices. The filter 150 may include a plurality of weight matrices. The OFM 160 may include a plurality of OFM matrices. For the first convolutional layer 110, which is also the first layer of the CNN 100, the IFM 140 is the input image 105. For the other convolutional layers, the IFM 140 may be an output of another convolutional layer 110 or an output of a pooling layer 120.

A convolution may be a linear operation that involves the multiplication of a weight operand in the filter 150 with a weight operand-sized patch of the IFM 140. A weight operand may be a weight matrix in the filter 150, such as a 2-dimensional array of weights, where the weights are arranged in columns and rows. Weights can be initialized and updated by backpropagation using gradient descent. The magnitudes of the weights can indicate importance of the filter 150 in extracting features from the IFM 140. A weight operand can be smaller than the IFM 140. The multiplication can be a element-wise multiplication between the weight operand-sized patch of the IFM 140 and the corresponding weight operand, which is then summed, always resulting in a single value. Because it results in a single value, the operation is often referred to as the “scalar product.”

In some embodiments, using a weight operand smaller than the IFM 140 is intentional as it allows the same weight operand (set of weights) to be multiplied by the IFM 140 multiple times at different points on the IFM 140. Specifically, the weight operand is applied systematically to each overlapping part or weight operand-sized patch of the IFM 140, left to right, top to bottom. The result from multiplying the weight operand with the IFM 140 one time is a single value. As the weight operand is applied multiple times to the IFM 140, the multiplication result is a two-dimensional array of output values that represent a weight operanding of the IFM 140. As such, the 2-dimensional output array from this operation is referred to a “feature map.”

In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculates the convolution of each of them with each of the weight operands. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new weight operands and generates a new feature map. The new feature map may also be normalized and resized. The new feature map can be weight operanded again by a further subsequent convolutional layer 110, and so on.

In some embodiments, a convolutional layer 110 has four hyperparameters: the number of weight operands, the size F weight operands (e.g., a weight operand is of dimensions F×F×D pixels), the S step with which the window corresponding to the weight operand is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depth-wise separable convolution, transposed convolution, and so on. The CNN 100 includes 16 convolutional layers 110. In other embodiments, the CNN 100 may include a different number of convolutional layers.

The pooling layers 120 down-sample feature maps generated by the convolutional layers, e.g., by summarizing the presents of features in the patches of the feature maps. A pooling layer 120 is placed between two convolutional layers 110: a preceding convolutional layer 110 (the convolutional layer 110 preceding the pooling layer 120 in the sequence of layers) and a subsequent convolutional layer 110 (the convolutional layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolutional layer 110 and applies a pooling operation to the feature maps. The pooling operation reduces the size of the feature maps while preserving their important characteristics. Accordingly, the pooling operation improves the efficiency of the CNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolutional layer 110 for further feature extraction. In some embodiments, the pooling layer 120 operates upon each feature map separately to create a new set of the same number of pooled feature maps.

The fully connected layers 130 are the last layers of the CNN. The fully connected layers 130 may be convolutional or not. The fully connected layers 130 receives an input operand. The input operand defines the output of the convolutional layers 110 and pooling layers 120 and includes the values of the last feature map generated by the last pooling layer 120 in the sequence. The fully connected layers 130 applies a linear combination and an activation function to the input operand and generates an individual partial sum. The individual partial sum may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and returns an operand of size N, where N is the number of classes in the image classification problem. In the embodiment of FIG. 1, N equals 3, as there are three objects 115, 125, and 135 in the input image. Each element of the operand indicates the probability for the input image 105 to belong to a class. To calculate the probabilities, the fully connected layers 130 multiply each input element by weight, makes the sum, and then applies an activation function (e.g., logistic if N=2, softmax if N>2). This is equivalent to multiplying the input operand by the matrix containing the weights. In an example, the individual partial sum includes three probabilities: a first probability indicating the object 115 being a tree, a second probability indicating the object 125 being a car, and a third probability indicating the object 135 being a person. In other embodiments where the input image 105 includes different objects or a different number of objects, the individual partial sum can be different.

### Example Point Grid System

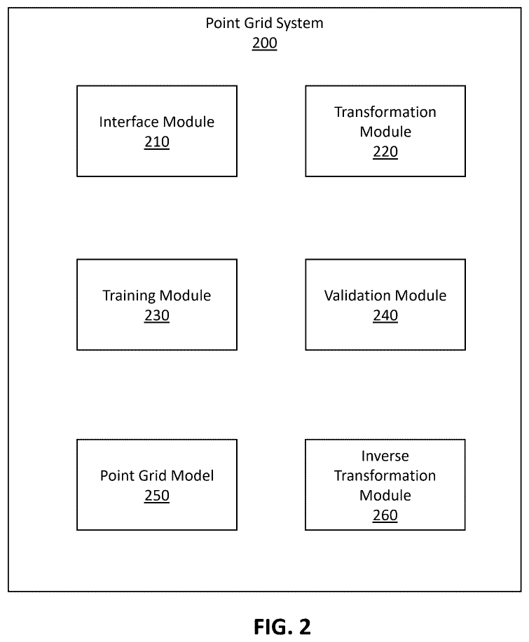

FIG. 2 is a block diagram of a point grid system 200, in accordance with various embodiments. The point grid system 200 facilitates convolutions on grid-structured data generated from semantic grid transformation of graph-structured data. The point grid system 200 includes an interface module 210, a transformation module 220, a training module 230, a validation module 240, a point grid model 250, and an inverse transformation module 260. In other embodiments, alternative configurations, different or additional components may be included in the point grid system 200. For instance, the point grid system 200 may include more than one point grid model. Further, functionality attributed to a component of the point grid system 200 may be accomplished by a different component included in the point grid system 200 or by a different system. For instance, some or all functionality attributed to the transformation module 220 or the inverse transformation module 260 may be accomplished by the point grid model 250.

The interface module 210 facilitates communications of the point grid system 200 with other systems. In some embodiments, the interface module 210 establishes communications between the point grid system 200 with an external database to receive graph-structured data that can be used to generate grid-structured data for training the point grid model 250 or for inference of the point grid model 250. The external database may be an image gallery that stores a plurality of images, such as 2D images, 3D images, etc. The interface module 210 may support the point grid system 200 to distribute the point grid model 250 to other systems, e.g., computing devices configured to apply the point grid model 250 to perform tasks. The computing devices may be an edge device, a client device, and so on. The interface module 210 may also support the point grid system 200 to distribute output of the inverse transformation module 260 to other systems.

The transformation module 220 performs semantic grid transformation on graphic-structured data samples. The transformation module 220 may receive the graphic-structured data samples from the interface module 210. A graph-structured data sample may be a graphical representation of one or more objects, e.g., an image of the one or more objects. An object may be a person, animal, plant, tree, building, vehicle, street, or other types of objects. Graphical representations can have irregular structures. For instance, a graphical representation of a person has contours of the person's body, which can be different from the graphical representation of another person, or even another graphical representation of the same person having a different pose. The transformation module 220 can transform graphical representations having irregular structures into grid representations having regular structures.

In some embodiments, the transformation module 220 transforms a graphical representation of an object to a grid representation of the object based on a grid. The grid has a regular structure, which can be adopted by the grid representation through the semantic grid transformation. The structure of the grid may be fixed and can either be 2D or 3D. An example grid structure includes a number of elements, each of which is defined by fixed boundaries. The elements may be arranged in rows and/or columns. For instance, a row or column may have one or more elements. The transformation module 220 may obtain (e.g., generate or retrieve from a database) grids with different structures. The transformation module 220 can select a grid based on the graph-structured data sample, e.g., based on a class of an object illustrated in the graph-structured data sample. For instance, the transformation module 220 may uses a different grid to transform a graphical representation of a person than a graphical representation of a tree.

In a semantic grid transformation of a graphical representation of an object, the transformation module 220 may identify graph nodes in the graphical representation. A graph node is a graphical representation of one or mor component of the object. In an example where the object is a person, the transformation module 220 may identify graph nodes that respectively represents different parts of the person's body, such as head, neck, torso, arms, legs, and so on. The transformation module 220 may identify the graph nodes based on body joints illustrated in the graphical representation of the person. The transformation module 220 may assign the graph nodes into different elements of the grid to form a grid representation of the object. The grid representation adopts both information from the graphical representation (e.g., the relationships between the graph nodes) and the regular structure of the grid.

In some embodiments, the transformation module 220 identifies an anchor node from the graph nodes and assigns the anchor node first. The transformation module 220 may select the anchor node randomly. Alternatively, the transformation module 220 may select the anchor node based on a rule. In an embodiment, the transformation module 220 may select the graph node that is connected to some or all the other graph node as the anchor node. For instance, the transformation module 220 may select the graph node representing the torso of a person as the anchor node of the person's graphical representation, or select the graph node representing the central trunk of a tree as the anchor node of the tree's graphical representation. In another embodiment, the anchor node may be a root node. After the anchor node is determined, the transformation module 220 assigns the anchor node to an element of the grid. The element may be pre-determined. In an example, the transformation module 220 assigns the anchor node to a particular row (or a particular element in the particular row) of the grid.

The transformation module 220 further assigns the other graph nodes (“secondary nodes”) based on the assignment of the anchor node. The transformation module 220 may determine a relationship between a secondary node and the anchor node and assigns the secondary node based on the relationship. The relationship may be a spatial relationship, such as a distance from the component represented by the secondary node to the component represented by the anchor node. The transformation module 220 may measure the distance based on the graphical representation of the object. The spatial relationship may be multi-dimensional. For instance, the transformation module 220 may determine a vertical node relationship (which may indicate a distance, orientation, or both between the two components along a first direction) and a horizontal node relationship (which may indicate a distance, orientation, or both between the two components along a second direction that is perpendicular or substantially perpendicular to the first direction).

The transformation module 220 assigns the secondary node based on its relationship with the anchor node. For instance, the transformation module 220 selects an element of the grid for the secondary node based on the relationship and the pre-determined element where the anchor node is assigned. The spatial relationship between the two elements may match the spatial relationship between the secondary node and the anchor node. In an example where the secondary node is below the anchor node in the graphical representation, the transformation module 220 assigns the secondary node to an element that is below the pre-determined element in the grid. In another example where the secondary node is at the left of the anchor node in the graphical representation, the transformation module 220 assigns the secondary node to an element that is at the left of the pre-determined element in the grid.

In some embodiments, the transformation module 220 may determine a hierarchy of the graph nodes, where the anchor node is the first tier, one or more secondary nodes that are closest to the anchor node is the second tier, one or more secondary nodes that are second closest to the anchor node is the third tier, and so on. In an example where the anchor node is assigned to the first row of the grid, the secondary nodes in the second tier are assigned to the second row, the secondary nodes in the third tier are assigned to the third row, and so on. The transformation module 220 may determine the hierarchy based on spatial relationships in one dimension. The transformation module 220 may further determine additional spatial relationships, which are in a different dimension, between secondary nodes in the same tier and assigns secondary nodes to different elements in the same row based on the additional spatial relationships.

The training module 230 trains the point grid model 250, which performs machine learning tasks with grid-structured data samples. In a process of training the point grid model 250, the training module 230 may form a training dataset. The training dataset includes training samples and ground-truth labels. The training samples may be grid-structured data samples provided by the transformation module 220. Each training samples may be associated with one or more ground-truth labels. A ground-truth label of a training sample may be a known or verified label that answers the problem or question that the point grid model 250 will be used to answer. In an example where the point grid model 250 is used to estimate pose, a ground-truth label may indicate a ground-truth pose of an object in the training sample. The ground-truth label may be a numerical value that indicates a pose or a likelihood of the object having a pose. In some embodiments, the training module 230 may also form validation datasets for validating performance of trained DNNs by the validation module 240. A validation dataset may include validation samples and ground-truth labels of the validation samples. The validation dataset may include different samples from the training dataset used for training the point grid model 250. In an embodiment, a part of a training dataset may be used to initially train the point grid model 250, and the rest of the training dataset may be held back as a validation subset used by the validation module 240 to validate performance of the point grid model 250. The portion of the training dataset not including the validation subset may be used to train the point grid model 250.

The training module 230 also determines hyperparameters for training the point grid model 250. Hyperparameters are variables specifying the training process. Hyperparameters are different from parameters inside the point grid model 250 (“internal parameters,” e.g., weights of filters). In some embodiments, hyperparameters include variables determining the architecture of the point grid model 250, such as number of hidden layers, etc. Hyperparameters also include variables which determine how the point grid model 250 is trained, such as batch size, number of epochs, etc. A batch size defines the number of training samples to work through before updating the parameters of the point grid model 250. The batch size is the same as or smaller than the number of samples in the training dataset. The training dataset can be divided into one or more batches. The number of epochs defines how many times the entire training dataset is passed forward and backwards through the entire network. The number of epochs defines the number of times that the DL algorithm works through the entire training dataset. One epoch means that each training sample in the training dataset has had an opportunity to update the internal parameters of the point grid model 250. An epoch may include one or more batches. The number of epochs may be 15, 150, 500, 1500, or even larger.

The training module 230 defines the architecture of the point grid model 250, e.g., based on some of the hyperparameters. The architecture of the point grid model 250 includes an input layer, an output layer, and a plurality of hidden layers. The input layer of the point grid model 250 may include tensors (e.g., a multi-dimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the point grid model 250 convert the input image to a feature map that is represented by a tensor specifying the feature map height, the feature map width, and the feature map channels (e.g., red, green, blue images include three channels). A pooling layer is used to reduce the spatial volume of input image after convolution. It is used between two convolution layers. A fully connected layer involves weights, biases, and neurons. It connects neurons in one layer to neurons in another layer. It is used to classify images between different category by training.

In the process of defining the architecture of the point grid model 250, the training module 230 also adds an activation function to a hidden layer or the output layer. An activation function of a layer transforms the weighted sum of the input of the layer to an output of the layer. The activation function may be, for example, a ReLU activation function, a tangent activation function, or other types of activation functions. After the training module 230 defines the architecture of the point grid model 250, the training module 230 inputs the training dataset into the point grid model 250. The training module 230 modifies the internal parameters of the point grid model 250 to minimize the error between labels of the training samples that are generated by the point grid model 250 and the ground-truth labels. In some embodiments, the training module 230 uses a cost function or loss function to minimize the error.

The training module 230 may train the point grid model 250 for a pre-determined number of epochs. The number of epochs is a hyperparameter that defines the number of times that the DL algorithm will work through the entire training dataset. One epoch means that each sample in the training dataset has had an opportunity to update the internal parameters of the point grid model 250. After the training module 230 finishes the pre-determined number of epochs, the training module 230 may stop updating the internal parameters of the point grid model 250, and the point grid model 250 is considered trained.

The validation module 240 verifies accuracy of the point grid model 250 after the point grid model 250 is trained. In some embodiments, the validation module 240 inputs samples in a validation dataset into the point grid model 250 and uses the outputs of the point grid model 250 to determine the model accuracy. In some embodiments, a validation dataset may be formed of some or all the samples in the training dataset. Additionally or alternatively, the validation dataset includes additional samples, other than those in the training sets. In some embodiments, the validation module 240 determines may determine an accuracy score measuring the precision, recall, or a combination of precision and recall of the DNN. The validation module 240 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 240 may compare the accuracy score with a threshold score. In an example where the validation module 240 determines that the accuracy score is lower than the threshold score, the validation module 240 instructs the training module 230 to re-train the point grid model 250. In one embodiment, the training module 230 may iteratively re-train the point grid model 250 until the occurrence of a stopping condition, such as the accuracy measurement indication that the point grid model 250 may be sufficiently accurate, or a number of training rounds having taken place.

The point grid model 250 performs machine learning tasks with grid-structured data. A machine learning task is a task of making an inference. The inference is a process of running available data (e.g., grid-structured data) into the point grid model 250 to generate an output. The output provides a solution to a problem or question that is being asked. The point grid model 250 can perform machine learning tasks for various applications, including applications that conventionally rely on graph-structured data, such as 2D-to-3D human pose lifting, skeleton based human action recognition, 3D mesh reconstruction, traffic navigation, social network analysis, recommend system, and scientific computing. In some embodiments, the point grid model 250 is a convolutional network that includes a plurality of hidden layers, e.g., one or more convolutional layers. An embodiment of the point grid model 250 may be the CNN 100 described above in conjunction with FIG. 1.

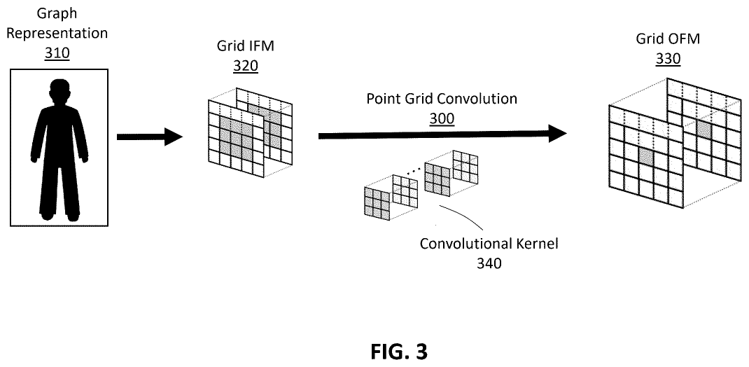

In some embodiments, the point grid model 250 receives a grid-structured data sample from the transformation module 220 and processes the grid-structured data sample to make a determination. A convolutional layer of the point grid model 250 may extract features from the grid-structured data sample or from an output of another layer of the point grid model 250. In an embodiment, the convolutional layer may generate variants of the grid-structured data sample and extracts features based on the variants. A variant of the grid-structured data sample may include some or all of the graph nodes in the grid-structured data sample but has a different structure from the grid-structured data sample or the other variants. The output of the point grid model 250 may be grid-structured data, such as a grid-structured feature map. More details regarding the point grid model 250 are provided below in conjunction with FIGS. 3 and 5-7.

The inverse transformation module 260 can transform grid-structured outputs of the point grid model 250 to graph-structured data. In an example, the point grid model 250 outputs a grid representation of an estimated pose of an object and sends the output to the inverse transformation module 260. The inverse transformation module 260 converts the grid representation to a graphical representation of the estimated pose, e.g., through a transformation that is an inverse of sematic grid transformation. Such a transformation is referred to as a semantic graph transformation. The semantic graph transformation may be necessary in certain applications where another system or a user needs graph-structured data as opposed to grid-structured data. The graphical representation generated by the inverse transformation module 260 may be a 3D graph that shows the estimated pose. In some embodiments, the inverse transformation module 260 may generate a 3D image or animation showing the estimated pose.

### Example Point Grid Convolution

FIG. 3 illustrates an example point grid convolution 300, in accordance with various embodiments. The point grid convolution 300 is a convolution on grid-structured data. The point grid convolution 300 may include multiply-accumulate (MAC) operations on a grid IFM 320 and a convolutional kernel 340. A result of the MAC operations is a grid OFM 330. The point grid convolution 300 may be a regular convolution, such as the convolution described above in conjunction with FIG. 1.

In the embodiments of FIG. 3, the grid IFM 320 is grid-structured data generated from a graph representation 310 of a person, e.g., through a sematic grid transformation by the transformation module 220 in FIG. 2. The grid IFM 320 may be a grid representation of the person and can include a plurality of input channels. Each channel may include an array including a number of rows and a number of columns. The convolutional kernel 340 includes a number of filters. The grid OFM 330 includes a plurality of output channels. The number of output channels in the grid OFM 330 may equal the number of filters in the convolutional kernel 340.

In some embodiments, the point grid convolution 300 may be formulated as

$${D}^{o u t} = W * {D}^{i n}$$

where Dⁱⁿ∈R^{H×P×C}^{ᵢₙ} denotes the grid IFM 320 with a spatial size of H×P and Cin channels, W∈R^{K×K×C}^{ᵢₙ}^{×C}^{ₒᵤₜ} denotes the convolutional kernel 340 having Cₒᵤₜ filters with a spatial size of K×K, e.g., K={1, 3, 5 . . . } based on spatial size of the grid IFM 320, and D^{out}∈R^{H×P×C}^{ₒᵤₜ} denotes the grid OFM 330 with a spatial size of H×P and Cₒᵤₜ channels.

The point grid convolution 300 may be performed by a convolutional layer (e.g., the first convolutional layer) of a point grid network, such as the point grid model 250 in FIG. 2. The grid OFM 330 is also grid-structured data. The grid OFM 330 may be further processed, e.g., through an activation function, another convolution, or other functions. In some embodiments, padding is performed before the point grid convolution 300, which can enable the grid IFM 320 and the grid OFM 330 to have the same spatial size, e.g., the same number of rows and same number of columns per channel. The grid IFM 320 and the grid OFM 330 may have different numbers of channels. In other embodiments, the grid IFM 320 and the grid OFM 330 have different spatial sizes.

### Example Semantic Grid Transformation

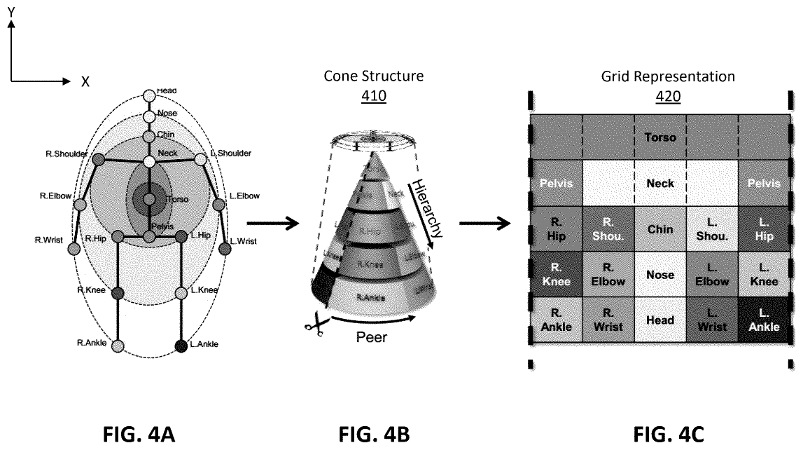

FIGS. 4A-4C illustrates an example semantic grid transformation, in accordance with various embodiments. The semantic grid transformation may be performed by the transformation module 220 in FIG. 2. FIG. 4A shows graph nodes identified from a graph representation of a person, such as the graph representation 310 in FIG. 3. Each graph node is shown as a circle of solid line in FIG. 4A and represents a different part of the person's body. For purpose of illustration, FIG. 4A shows 18 graph nodes representing the head, nose, chin, neck, right shoulder (“R. Shoulder” or “R. Shou.”), left shoulder (“L. Shoulder” or “L. Shou.”), right elbow (“R. Elbow”), torso, left elbow (“L. Elbow”), right wrist (“R. Wrist”), right hip (“R. Hip”), pelvis, left hip (“L. Hip”), left wrist (“L. Wrist”), right knee (“R. Knee”), left knee (“L. Knee”), right ankle (“R. Ankle”), and left ankle (“L. Ankle”). In other embodiments, more, fewer, or different graph nodes identified from the graph representation of the person.

The Torso graph node is used as the anchor node of the semantic grid transformation, e.g., based on a determination that the Torso graph node is connected to most of the other graph nodes and/or that the Torso graph node is at the center or close to the center of the graph representation of the person. As described above, a spatial relationship between the Torso graph node and each of the other graph nodes may be determined. The spatial relationship may be a vertical relationship (e.g., an ancestor-descendant relationship), a horizontal relationship (e.g., a peer relationship), or a combination of both. In some embodiments, the spatial relationship may be one or more distances from the Torso graph node to the other graph node, such as a linear distance from the Torso graph node to the other graph node, a horizontal distance along the X-axis (e.g., a distance from a projection of the Torso graph node on the X-axis to a projection of the other graph node on the X-axis), a distance along the Y-axis (e.g., a distance from a projection of the Torso graph node on the Y-axis to a projection of the other graph node on the Y-axis), etc.

Also, a hierarchy is determined based on the position of the other graph nodes relative to the Torso graph node. The hierarchy includes a sequence of tiers, each tier includes one or more graph nodes. The tiers are represented by dashed shapes (circles and ovals) in FIG. 4A. The first tier includes the Torso graph node and is represented by the smallest dashed shape that encloses the Torso graph node. The second tier includes the Neck graph node and Pelvis graph node and is represented by the second smallest dashed shape. Similarly, the third tier includes the R. Hip, R. Shoulder, Chin, L. Shoulder, and L. Hip graph nodes; the fourth tier includes the R. Knee, R. Elbow, Nose, L. Elbow, and L. Knee graph nodes, and the fifth tier includes the R. Ankle, R. Wrist, Head, L. Wrist, and L. Ankle graph nodes.

In FIG. 4B, a cone structure 410 is formed based on the hierarchy. The cone includes five layers, each layer corresponds to a tier of the hierarchy and the graph nodes in the tier are arranged in the corresponding layer of the cone. As shown in FIG. 4B, the Torso graph node is in the first/top layer, the graph nodes of the second tier are in the second layer, the graph nodes of the third tier are in the third layer, and so on. The arrangement of the graph nodes in the cone structure 410 of FIG. 4B reflects the relationships between the graph nodes shown in FIG. 4A. Even though FIG. 4B shows a cone structure 410, in other embodiments, the graph nodes can be arranged in different structures, such as cylinder, and so on.

In FIG. 4C, the graph nodes arranged in the cone structure 410 are “flattened” and a 2D grid representation 420 of the person is generated from the cone structure 410. The grid representation 420 has a grid structure including five rows and five columns, i.e., 25 elements in total. The number of rows equals the number of tiers in the hierarchy. The number of columns equals the number of graph nodes in the tier that has the most graph nodes, i.e., the fifth tier. Each graph nodes are in one of the 25 elements. The graph nodes in the same tier are in the same row. The Torso graph node is in the middle element of the first row. The grid representation 420 may be an embodiment of the grid IFM 320 in FIG. 3. The grid representation 420 includes empty grid elements, e.g., in the first row and the second row. An empty grid element may be filled with a graph node in the same row. For instance, some or all of the four empty elements in the first row may be filled with the Torso graph node.

The semantic grid transformation shown in FIGS. 4A-4C may be defined as

$$D = ∅ ( G )$$

where Ø denotes the transformation function for mapping node indices, G∈R^{J×C} denotes the input graph sample (i.e., the graph representation) having j nodes and each node has C feature channels, and D∈R^{H×P×C} denotes the output of a weave-like grid (e.g., the grid representation 420) with a spatial size of H×P. The weave-like grid may have a rectangular shape or square shape, depending on the values of H and P. Even though the semantic grid transformation includes the formation of the cone structure 410 in FIG. 4B, the grid representation 420 may be generated directly from the graphical representation of the person in other embodiments, and the step shown in FIG. 4B may be skipped.

### Example 3D Pose Estimation

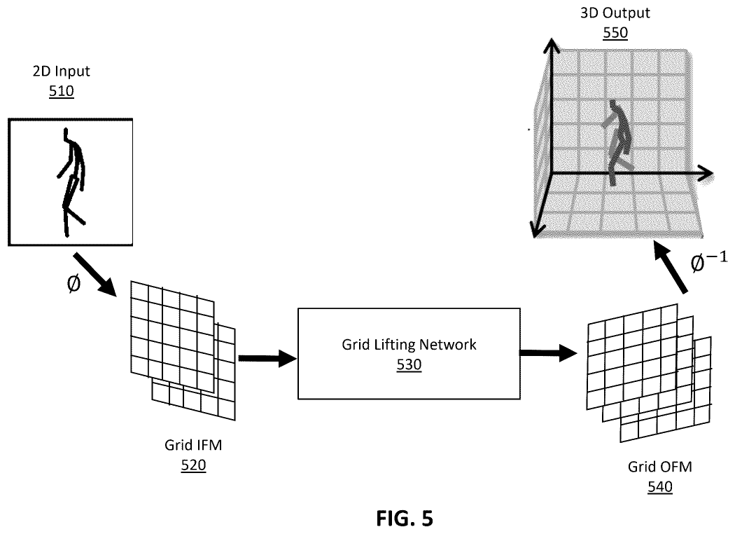

FIG. 5 illustrates an example 3D pose estimation based on a 2D input 510, in accordance with various embodiments. The 2D input 510 is a graphical representation of a person, which may show a 2D pose of the person. As shown in FIG. 5, the 2D input 510 is converted to a grid IFM 520, e.g., through a semantic grid transformation, Ø. The semantic grid transformation may be done by the transformation module 220 in FIG. 2. In some embodiments, the grid IFM 520 is a result of padding that is applied on a grid-representation of the 2D input 510.

As shown in FIG. 5, the grid IFM 520 is input into a grid lifting network 530. The grid lifting network 530 may be an embodiment of the point grid model 250. The grid lifting network 530 has been trained to process grid-structured data samples, e.g., through point grid convolutions, to estimate 3D pose. The grid lifting network 530 may be trained with a training dataset that includes grid-structured data samples and ground-truth grid pose of the samples. In some embodiments, the grid lifting network 530 may be trained by minimizing an error L between the predicted 3D grid pose D_{3D} and the ground-truth

$${D}_{3 D}^{G T}$$

over the training dataset:

$$L = {‖ {D}_{3 D} - {D}_{3 D}^{G T} ‖}^{2}$$

where L denotes a 2-norm distance.

After the training, the grid lifting network 530 can estimate 3D pose through inferences. An inference is a process of processing an input, such as the grid IFM 520, and generates an output, such as the grid OFM 540, which indicates a 3D pose. In some embodiments, the spatial size of the grid IFM 520 and the spatial size of the grid OFM 540 are the same, but the number of channels may be different. For instance, the grid IFM 520 may have two channels representing 2D joint locations, versus the grid OFM 540 may have three channels representing 3D joint locations. In other embodiments (e.g., embodiments that uses a dense 2D pose input to estimate a sparse 3D pose and one or more 3D joint locations are estimated from all 2D joint locations), the spatial size of the grid IFM 520 and the spatial size of the grid OFM 540 may be different.

The grid OFM 540 is then converted to a 3D output 550 through an inverse transformation Ø⁻¹. The inverse transformation may be done by the inverse transformation module 260 in FIG. 2. The 3D output 550 is a 3D graph representation of the estimated pose. In some embodiments, if a particular Ø is defined, an inverse transformation Ø⁻¹ that converts D back to G can be easily obtained by mapping grids back into J unique nodes. For repetitive grids, feature merging is applied in the inverse transformation.

As shown in FIG. 5, the lifting process includes the semantic grid transformation (Ø⁻¹), the inference of the grid lifting network 530, and the inverse transformation (Ø). The lifting process may be represented by:

$${G}_{3 D} = {∅}^{- 1} ( F ( ∅ ( {G}_{2 D} ) ) )$$

where G_{3D} represents the 3D output 550, F denotes the inference of the grid lifting network 530, and G_{2D} denotes the 2D input 510.

### Example Grid Lifting Network

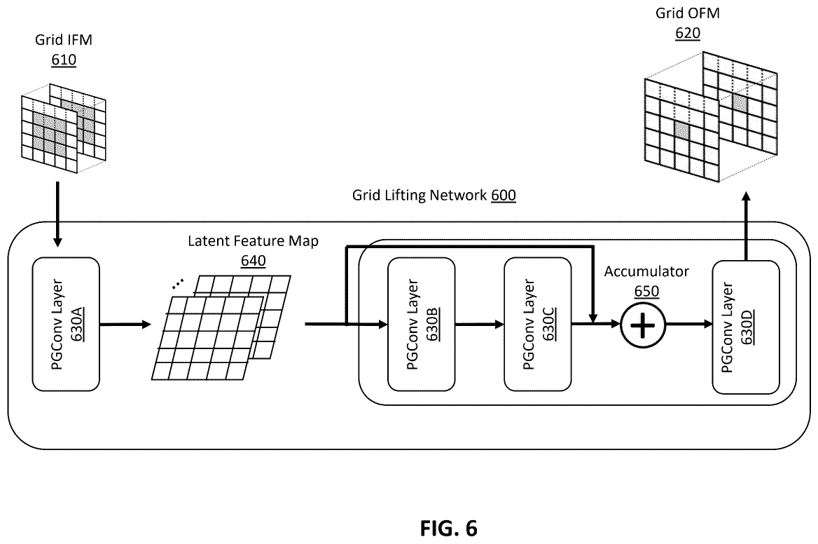

FIG. 6 illustrates an example grid lifting network 600, in accordance with various embodiments. The grid lifting network 600 can receive a grid IFM 610, which is grid-structured data converted from an 2D input, and generates a grid OFM 620, which can be further converted to an 3D input. In some embodiments, the grid IFM 610 is a result of applying padding on the grid-structured data. The padding can facilitate that the grid IFM 610 and the grid OFM 620 have the same spatial size. The grid lifting network 600 may be an embodiment of the grid lifting network 530 in FIG. 5.

As shown in FIG. 6, the grid lifting network 600 includes multiple point grid convolutional (“PGConv”) layers 630A-630D, which are collectively referred to as PGConv layers 630 or PGConv layer 630. Each PGConv layer 630 performs a point grid convolution. The PGConv layers 630 are arranged in a sequence. A PGConv layer 630 may receive the output of the preceding PGConv layer 630 and performs a point grid convolution on the output of the preceding PGConv layer 630. In the embodiments of FIG. 6, the first PGConv layer 630A receives the grid IFM 610 and generates a latent feature map 640. The latent feature map 640 are “hidden” features, as opposed to observed features, such as the grid OFM 620. Each of the PGConv layers 630A-C generates a latent feature map. The spatial size of the latent feature maps may be fixed throughout the lifting process.

In addition to the PGConv layers 630, the grid lifting network 600 also includes an accumulator 650 that accumulates the latent feature map 640 and the output of the PGConv layer 630C. In other embodiments, the grid lifting network 600 may include other operations that perform additional operation in the inference, such as activation, pooling, etc.

### Example Point Grid Convolutional Layer

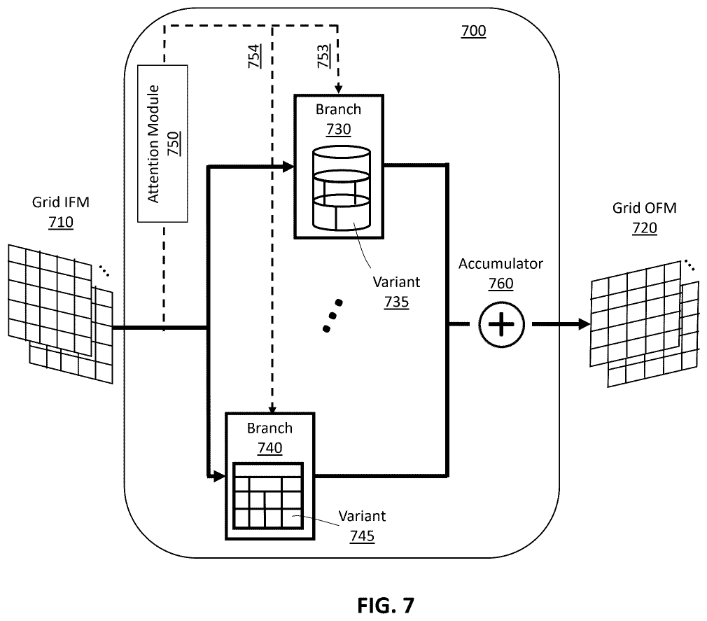

FIG. 7 illustrates an example PGConv layer 700 including multiple branches, in accordance with various embodiments. The PGConv layer 700 may be an embodiment of a PGConv layer 630 in FIG. 6. As shown in FIG. 7, the PGConv layer 700 receives a grid IFM 710 and output a grid OFM 720. The grid IFM 710 may be the grid IFM 610, the latent feature map 640, or a different latent feature map. The grid OFM 720 may be the latent feature map 640, a different latent feature map, or the grid OFM 620.

The PGConv layer 700 includes multiple branches. For purpose of simplicity and illustration, FIG. 7 shows two branches 730 and 740. In other embodiments, the PGConv layer 700 may include more branches. The branches 730 and 740 generate variants 735 and 740, respectively. The variants 735 and 745 are also grid-structured data. The variants 735 and 745 have different structures but may have same graph nodes. For purpose of illustration, the variant 735 has a cylindrical structure, versus variant 745 has a rectangular structure. In other embodiments, a variant of the grid IFM 710 may have other shapes, e.g., donut shape, square, bucket shape, pipe shape, and so on. The branches 730 and 740 may use different padding approaches to form the different variants. Padding, in some embodiments, can ensure that the grid IFM and grid OFM have the same spatial size, e.g., the same number of rows and same number of columns per channel, but the grid IFM and grid OFM may have different numbers of channels. Each branch may extract features from its variant.

The PGConv layer 700 also includes an attention module 750 that generates scalar kernels for the branches 730 and 740. For instance, the attention module 750 may generate a scalar kernel 753 for the branch 730 and a scalar kernel 754 for the branch 740 based on the grid IFM 710. The branch 730 may perform an element-wise multiplication operation on the scalar kernel 753 and a convolutional filter for the branch 730. The branch 740 can further use the result of the element-wise multiplication operation and the variant 735 to perform a convolutional operation. Similarly, the branch 740 may perform an element-wise multiplication operation on the scalar kernel 754 and a convolutional filter, and further use the result of the element-wise multiplication operation and the variant 745 to perform a convolutional operation. The introduction of the scalar kernels 753 and 754 can augment adaptiveness of the convolutional operations to the input of the PGConv layer 700. Conventionally, the internal parameters for convolutional operations are convolutional filters, values in which are determined during the training of the grid lifting network 600 and do not change with change in the grid IFM 710. In contrast, the internal parameters of the convolutional operations by the PGConv layer 700 further include the scalar kernels 753 and 754, values of which are determined based on the grid IFM 710. In other words, the internal parameters of the convolutional operations by the PGConv layer 700 can change as the grid IFM 710 changes. Such convolutional operations are dynamic. Through the element-wise multiplication operation, the convolutional filter can be augmented with flexible adaptiveness.

In some embodiments, the attention module 750 applies an attention function on the grid IFM 710, and the attention function returns the scalar kernels 753 and 754. The attention function may be determined during the training of the grid lifting network 600. For instance, the attention function includes one or more parameters, the values of which are determined through the training of the grid lifting network 600.

As shown in FIG. 7, the PGConv layer 700 also includes an accumulator 760 that accumulates features generated by the branches 730 and 740. The result of the accumulation may be the grid OFM 720. The grid OFM 720 may be provided to another PGConv layer for further point grid convolution, or be output by the grid lifting network 600 and be used to generate a 3D graph representation of an estimated pose.

### Example DL Environment

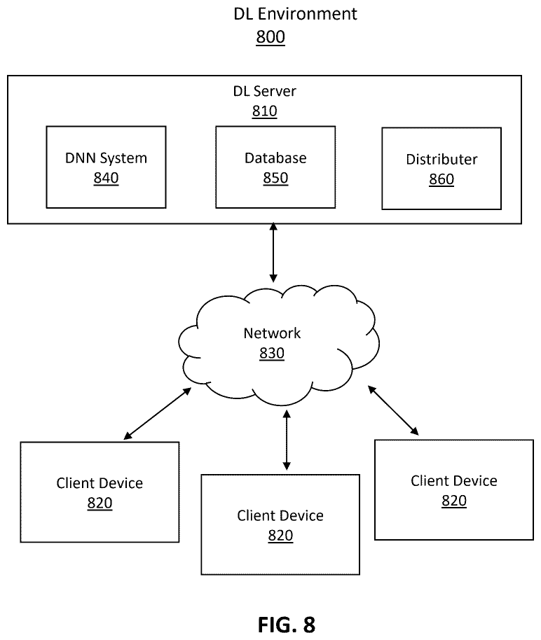

FIG. 8 illustrates a DL environment 800, in accordance with various embodiments. The DL environment 800 includes a DL server 810 and a plurality of client devices 820 (individually referred to as client device 820). The DL server 810 is connected to the client devices 820 through a network 830. In other embodiments, the DL environment 800 may include fewer, more, or different components.

The DL server 810 trains DL models using neural networks. A neural network is structured like the human brain and consists of artificial neurons, also known as nodes. These nodes are stacked next to each other in three types of layers: input layer, hidden layer(s), and output layer. Data provides each node with information in the form of inputs. The node multiplies the inputs with random weights, calculates them, and adds a bias. Finally, nonlinear functions, also known as activation functions, are applied to determine which neuron to fire. The DL server 810 can use various types of neural networks, such as DNN, recurrent neural network (RNN), generative adversarial network (GAN), long short-term memory network (LSTMN), and so on. During the process of training the DL models, the neural networks use unknown elements in the input distribution to extract features, group objects, and discover useful data patterns. The DL models can be used to solve various problems, e.g., making predictions, classifying images, and so on. The DL server 810 may build DL models specific to particular types of problems that need to be solved. A DL model is trained to receive an input and outputs the solution to the particular problem.

In FIG. 8, the DL server 810 includes a DNN system 840, a database 850, and a distributer 860. The DNN system 840 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the CNN 100 described above in conjunction with FIG. 1 or the point grid model 250 described above in conjunction with FIG. 2. An embodiment of the DNN system 840 is the point grid system 200 described above in conjunction with FIG. 2.

The database 850 stores data received, used, generated, or otherwise associated with the DL server 810. For example, the database 850 stores a training dataset that the DNN system 840 uses to train DNNs. In an embodiment, the training dataset is an image gallery that can be used to train a DNN for classifying images, estimating poses, and so on. The training dataset may include data received from the client devices 820. As another example, the database 850 stores hyperparameters of the neural networks built by the DL server 810.

The distributer 860 distributes DL models generated by the DL server 810 to the client devices 820. In some embodiments, the distributer 860 receives a request for a DNN from a client device 820 through the network 830. The request may include a description of a problem that the client device 820 needs to solve. The request may also include information of the client device 820, such as information describing available computing resource on the client device. The information describing available computing resource on the client device 820 can be information indicating network bandwidth, information indicating available memory size, information indicating processing power of the client device 820, and so on. In an embodiment, the distributer may instruct the DNN system 840 to generate a DNN in accordance with the request. The DNN system 840 may generate a DNN based on the information in the request. For instance, the DNN system 840 can determine the structure of the DNN and/or train the DNN in accordance with the request.

In another embodiment, the distributer 860 may select the DNN from a group of pre-existing DNNs based on the request. The distributer 860 may select a DNN for a particular client device 820 based on the size of the DNN and available resources of the client device 820. In embodiments where the distributer 860 determines that the client device 820 has limited memory or processing power, the distributer 860 may select a compressed DNN for the client device 820, as opposed to an uncompressed DNN that has a larger size. The distributer 860 then transmits the DNN generated or selected for the client device 820 to the client device 820.

In some embodiments, the distributer 860 may receive feedback from the client device 820. For example, the distributer 860 receives new training data from the client device 820 and may send the new training data to the DNN system 840 for further training the DNN. As another example, the feedback includes an update of the available computer resource on the client device 820. The distributer 860 may send a different DNN to the client device 820 based on the update. For instance, after receiving the feedback indicating that the computing resources of the client device 820 have been reduced, the distributer 860 sends a DNN of a smaller size to the client device 820.

The client devices 820 receive DNNs from the distributer 860 and applies the DNNs to perform machine learning tasks, e.g., to solve problems or answer questions. In various embodiments, the client devices 820 input images into the DNNs and uses the output of the DNNs for various applications, e.g., visual reconstruction, augmented reality, robot localization and navigation, medical diagnosis, weather prediction, and so on. A client device 820 may be one or more computing devices capable of receiving user input as well as transmitting and/or receiving data via the network 830. In one embodiment, a client device 820 is a conventional computer system, such as a desktop or a laptop computer. Alternatively, a client device 820 may be a device having computer functionality, such as a personal digital assistant (PDA), a mobile telephone, a smartphone, an autonomous vehicle, or another suitable device. A client device 820 is configured to communicate via the network 830. In one embodiment, a client device 820 executes an application allowing a user of the client device 820 to interact with the DL server 810 (e.g., the distributer 860 of the DL server 810). The client device 820 may request DNNs or send feedback to the distributer 860 through the application. For example, a client device 820 executes a browser application to enable interaction between the client device 820 and the DL server 810 via the network 830. In another embodiment, a client device 820 interacts with the DL server 810 through an application programming interface (API) running on a native operating system of the client device 820, such as IOS® or ANDROID™.

In an embodiment, a client device 820 is an integrated computing device that operates as a standalone network-enabled device. For example, the client device 820 includes display, speakers, microphone, camera, and input device. In another embodiment, a client device 820 is a computing device for coupling to an external media device such as a television or other external display and/or audio output system. In this embodiment, the client device 820 may couple to the external media device via a wireless interface or wired interface (e.g., an HDMI cable) and may utilize various functions of the external media device such as its display, speakers, microphone, camera, and input devices. Here, the client device 820 may be configured to be compatible with a generic external media device that does not have specialized software, firmware, or hardware specifically for interacting with the client device 820.

The network 830 supports communications between the DL server 810 and client devices 820. The network 830 may comprise any combination of local area and/or wide area networks, using both wired and/or wireless communication systems. In one embodiment, the network 830 may use standard communications technologies and/or protocols. For example, the network 830 may include communication links using technologies such as Ethernet, 8010.11, worldwide interoperability for microwave access (WiMAX), 3G, 4G, code division multiple access (CDMA), digital subscriber line (DSL), etc. Examples of networking protocols used for communicating via the network 830 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 830 may be represented using any suitable format, such as hypertext markup language (HTML) or extensible markup language (XML). In some embodiments, all or some of the communication links of the network 830 may be encrypted using any suitable technique or techniques.

Example Method of Modeling Graph-Structured Data with Point Grid Convolution

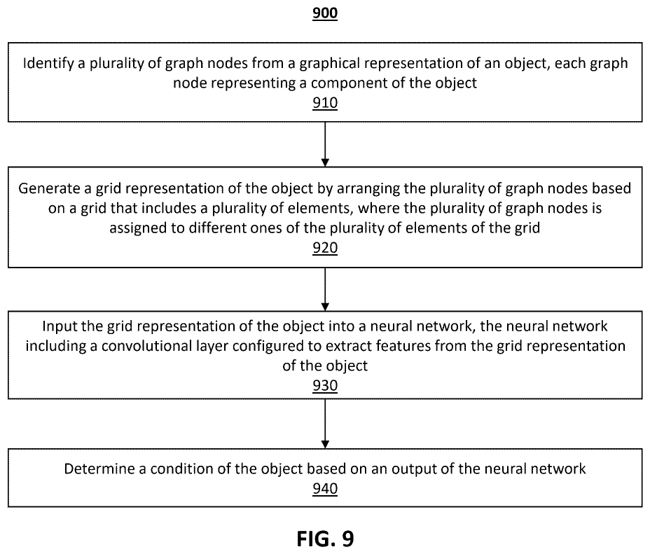

FIG. 9 is a flowchart showing a method 900 of modeling graph-structured data with point grid convolution, in accordance with various embodiments. The method 900 may be performed by the point grid system 200 in FIG. 2. Although the method 900 is described with reference to the flowchart illustrated in FIG. 9, many other methods for training a DNN through dense-connection based knowledge distillation may alternatively be used. For example, the order of execution of the steps in FIG. 9 may be changed. As another example, some of the steps may be changed, eliminated, or combined.

The point grid system 200 identifies 910 a plurality of graph nodes from a graphic representation of an object. Each graph node represents a component of the object. The graphical representation may be a 2D image. In an example where the object is a person, the point grid system 200 may identify the graph nodes based on locations of body joints shown in the graphical representation of the person.

The point grid system 200 generates 920 a grid representation of the object by arranging the plurality of graph nodes based on a grid. The grid includes a plurality of elements. The plurality of graph nodes is assigned to different ones of the plurality of elements of the grid. In some embodiments, the point grid system 200 selects an anchor node from the plurality of graph nodes and assigns the anchor node to a pre-determined element of the plurality of elements. Further, the point grid system 200 assigns one or more other graph nodes of the plurality of graph nodes to one or more other elements of the plurality of elements. The plurality of elements may be arranged in a sequence of rows, and the pre-determined element may be in a first row in the sequence.

In some embodiments, the point grid system 200 arranges the one or more other graph nodes into a first tier and a second tier. The first tier includes one or more first graph nodes. The second tier includes one or more second graph nodes. The point grid system 200 assigns the one or more first graph nodes to a second row in the sequence, and assigns the one or more second graph nodes to a third row in the sequence. The first row precedes the second row and the third row in the sequence. In an example, a distance from a component represented by the anchor node to a component represented by a graph node in the first tier is shorter than a distance from the component represented by the anchor node to a component represented by a graph node in the second tier. And the second row precedes the third row in the sequence in the example.

In some embodiments, the point grid system 200 determines a relationship between a graph node and the anchor node based on the graphic representation. The point grid system 200 selects an element from the plurality of elements based on the pre-determined element and the relationship and assigns the graph node to the element. The graph node may represent a first component of the object, the anchor node may represent a second component of the object. The point grid system 200 may determine the relationship between the graph node and the anchor node by determining the relationship based on a distance from the first component to the second component in the graphic representation.

The point grid system 200 inputs 930 the grid representation of the object into a neural network. The neural network comprises a convolutional layer configured to extract features from the grid representation of the object. The neural network may be the point grid model 250 in FIG. 2, the grid lifting network 530 in FIG. 5, or the grid lifting network 600 in FIG. 6. The convolutional layer may generate a first grid representation and a second grid representation based on the grid representation. The first grid representation has a different structure from the second grid representation. The first grid representation or second grid representation may include the graph nodes. The convolutional layer can generate the features based on the first grid representation and a second grid representation. The convolutional layer may be the point grid convolutional layer in FIG. 3, a PGConv layer 630 in FIG. 6, or the PGConv layer 700 in FIG. 7.

The point grid system 200 determines 940 a condition of the object based on an output of the neural network. The output of the neural network may be grid-structured data, e.g., grid-structured data showing the object. The condition of the object may be a pose of the object, a mood of the object, an action of the object, an orientation of the object, an interest of the object, and so on. In some embodiments, the condition may be a condition at the time when the graphical representation of the object was captured. In other embodiments, the condition may be a predicted condition, such as a condition for a time after the graphical representation of the object was captured. In some embodiments, the point grid system 200 determines a pose of the object based on the output of the neural network. In some embodiments, the graphic representation is a 2D graphic representation. The point grid system 200 may generate a 3D graphic representation of the object based on the output of the neural network.

### Example Computing Device

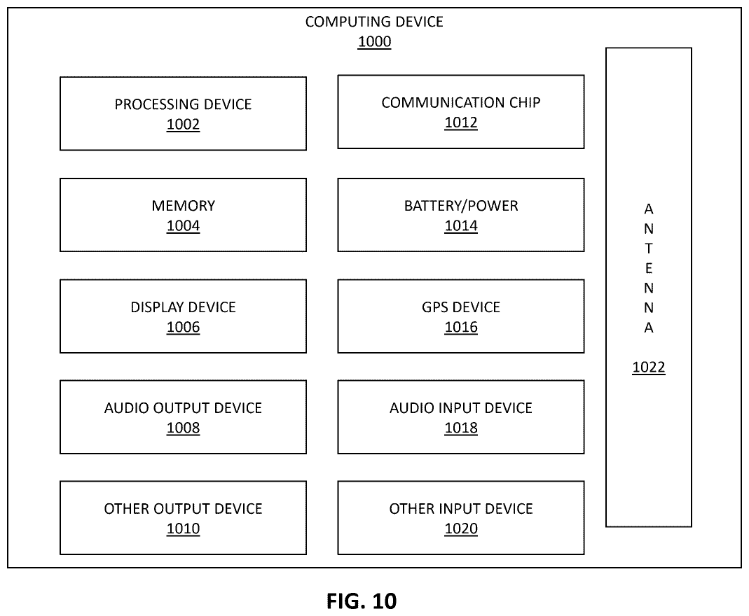

FIG. 10 is a block diagram of an example computing device 1000, in accordance with various embodiments. A number of components are illustrated in FIG. 10 as included in the computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a single system on a chip (SoC) die. Additionally, in various embodiments, the computing device 1000 may not include one or more of the components illustrated in FIG. 10, but the computing device 1000 may include interface circuitry for coupling to the one or more components. For example, the computing device 1000 may not include a display device 1006, but may include display device interface circuitry (e.g., a connector and driver circuitry) to which a display device 1006 may be coupled. In another set of examples, the computing device 1000 may not include an audio input device 1018 or an audio output device 1008, but may include audio input or output device interface circuitry (e.g., connectors and supporting circuitry) to which an audio input device 1018 or audio output device 1008 may be coupled.

The computing device 1000 may include a processing device 1002 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 1002 may include one or more digital signal processors (DSPs), application-specific ICs (ASICs), CPUs, GPUs, cryptoprocessors (specialized processors that execute cryptographic algorithms within hardware), server processors, or any other suitable processing devices. The computing device 1000 may include a memory 1004, which may itself include one or more memory devices such as volatile memory (e.g., DRAM), nonvolatile memory (e.g., read-only memory (ROM)), flash memory, solid state memory, and/or a hard drive. In some embodiments, the memory 1004 may include memory that shares a die with the processing device 1002. In some embodiments, the memory 1004 includes one or more non-transitory computer-readable media storing instructions executable to perform operations for modeling graph-structured data with point grid convolution, e.g., the method 900 described above in conjunction with FIG. 9 or the operations performed by the point grid system 200 described above in conjunction with FIG. 2. The instructions stored in the one or more non-transitory computer-readable media may be executed by the processing device 1002.

In some embodiments, the computing device 1000 may include a communication chip 1012 (e.g., one or more communication chips). For example, the communication chip 1012 may be configured for managing wireless communications for the transfer of data to and from the computing device 1000. The term “wireless” and its derivatives may be used to describe circuits, devices, DNN accelerators, methods, techniques, communications channels, etc., that may communicate data through the use of modulated electromagnetic radiation through a nonsolid medium. The term does not imply that the associated devices do not contain any wires, although in some embodiments they might not.

The communication chip 1012 may implement any of a number of wireless standards or protocols, including but not limited to Institute for Electrical and Electronic Engineers (IEEE) standards including Wi-Fi (IEEE 1002.13 family), IEEE 1002.16 standards (e.g., IEEE 1002.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 1002.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 1002.16 standards. The communication chip 1012 may operate in accordance with a Global system for Mobile Communication (GSM), General Packet Radio Service (GPRS), Universal Mobile Telecommunications system (UMTS), High Speed Packet Access (HSPA), Evolved HSPA (E-HSPA), or LTE network. The communication chip 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1012 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1012 may operate in accordance with other wireless protocols in other embodiments. The computing device 1000 may include an antenna 1022 to facilitate wireless communications and/or to receive other wireless communications (such as AM or FM radio transmissions).

In some embodiments, the communication chip 1012 may manage wired communications, such as electrical, optical, or any other suitable communication protocols (e.g., the Ethernet). As noted above, the communication chip 1012 may include multiple communication chips. For instance, a first communication chip 1012 may be dedicated to shorter-range wireless communications such as Wi-Fi or Bluetooth, and a second communication chip 1012 may be dedicated to longer-range wireless communications such as global positioning system (GPS), EDGE, GPRS, CDMA, WiMAX, LTE, EV-DO, or others. In some embodiments, a first communication chip 1012 may be dedicated to wireless communications, and a second communication chip 1012 may be dedicated to wired communications.

The computing device 1000 may include battery/power circuitry 1014. The battery/power circuitry 1014 may include one or more energy storage devices (e.g., batteries or capacitors) and/or circuitry for coupling components of the computing device 1000 to an energy source separate from the computing device 1000 (e.g., AC line power).

The computing device 1000 may include a display device 1006 (or corresponding interface circuitry, as discussed above). The display device 1006 may include any visual indicators, such as a heads-up display, a computer monitor, a projector, a touchscreen display, a liquid crystal display (LCD), a light-emitting diode display, or a flat panel display, for example.

The computing device 1000 may include an audio output device 1008 (or corresponding interface circuitry, as discussed above). The audio output device 1008 may include any device that generates an audible indicator, such as speakers, headsets, or earbuds, for example.

The computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

The computing device 1000 may include a GPS device 1016 (or corresponding interface circuitry, as discussed above). The GPS device 1016 may be in communication with a satellite-based system and may receive a location of the computing device 1000, as known in the art.

The computing device 1000 may include an other output device 1013 (or corresponding interface circuitry, as discussed above). Examples of the other output device 1013 may include an audio codec, a video codec, a printer, a wired or wireless transmitter for providing information to other devices, or an additional storage device.

The computing device 1000 may include an other input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1000 may have any desired form factor, such as a handheld or mobile computing system (e.g., a cell phone, a smart phone, a mobile internet device, a music player, a tablet computer, a laptop computer, a netbook computer, an ultrabook computer, a PDA, an ultramobile personal computer, etc.), a desktop computing system, a server or other networked computing component, a printer, a scanner, a monitor, a set-top box, an entertainment control unit, a vehicle control unit, a digital camera, a digital video recorder, or a wearable computing system. In some embodiments, the computing device 1000 may be any other electronic device that processes data.

### SELECT EXAMPLES

The following paragraphs provide various examples of the embodiments disclosed herein.

Example 1 provides a method, the method including identifying a plurality of graph nodes from a graphical representation of an object, each graph node representing a component of the object; generating a grid representation of the object by arranging the plurality of graph nodes based on a grid that includes a plurality of elements, where the plurality of graph nodes is assigned to different ones of the plurality of elements of the grid; inputting the grid representation of the object into a neural network, the neural network including a convolutional layer configured to extract features from the grid representation of the object; and determining a condition of the object based on an output of the neural network.

Example 2 provides the method of example 1, where generating the grid representation of the object includes selecting an anchor node from the plurality of graph nodes; assigning the anchor node to a pre-determined element of the plurality of elements; and assigning one or more other graph nodes of the plurality of graph nodes to one or more other elements of the plurality of elements.

Example 3 provides the method of example 2, where the plurality of elements is arranged in a sequence of rows, and the pre-determined element is in a first row in the sequence.

Example 4 provides the method of example 3, where the one or more other graph nodes are a group of graph nodes, and assigning the one or more other graph nodes of the plurality of graph nodes to the one or more other elements of the plurality of elements includes arranging the one or more other graph nodes into a first tier and a second tier, the first tier including one or more first graph nodes, the second tier including one or more second graph nodes, assigning the one or more first graph nodes to a second row in the sequence, and assigning the one or more second graph nodes to a third row in the sequence, where the first row precedes the second row and the third row in the sequence.

Example 5 provides the method of example 4, where a distance from a component represented by the anchor node to a component represented by a graph node in the first tier is shorter than a distance from the component represented by the anchor node to a component represented by a graph node in the second tier, and the second row precedes the third row in the sequence.

Example 6 provides the method of example 2, where assigning the one or more other graph nodes of the plurality of graph nodes to the one or more other elements of the plurality of elements includes determining a relationship between a graph node and the anchor node based on the graphical representation; selecting an element from the plurality of elements based on the pre-determined element and the relationship; and assigning the graph node to the element.

Example 7 provides the method of example 6, where the graph node represents a first component of the object, the anchor node represents a second component of the object, and determining the relationship between the graph node and the anchor node includes determining the relationship based on a distance from the first component to the second component in the graphical representation.

Example 8 provides the method of example 1, where determining a condition of the object based on the output of the neural network includes determining a pose of the object based on the output of the neural network.

Example 9 provides the method of example 1, where the graphical representation is a two-dimensional graphical representation, and determining a condition of the object based on the output of the neural network includes generating a three-dimensional graphical representation of the object based on the output of the neural network.

Example 10 provides the method of example 1, where the convolutional layer is configured to extract the features from the grid representation of the object by generating a first grid representation and a second grid representation based on the grid representation, the first grid representation having a different structure from the second grid representation; and generating the features based on the first grid representation and a second grid representation.

Example 11 provides one or more non-transitory computer-readable media storing instructions executable to perform operations for training a target neural network, the operations including identifying a plurality of graph nodes from a graphical representation (i.e., a 2D graphical representation) of an object, each graph node representing a component of the object; generating a grid representation of the object by arranging the plurality of graph nodes based on a grid that includes a plurality of elements, where the plurality of graph nodes is assigned to different ones of the plurality of elements of the grid; inputting the grid representation of the object into a neural network, the neural network including a convolutional layer configured to extract features from the grid representation of the object; and determining a condition of the object based on an output of the neural network.

Example 12 provides the one or more non-transitory computer-readable media of example 11, where generating the grid representation of the object includes selecting an anchor node from the plurality of graph nodes; assigning the anchor node to a pre-determined element of the plurality of elements; and assigning one or more other graph nodes of the plurality of graph nodes to one or more other elements of the plurality of elements.

Example 13 provides the one or more non-transitory computer-readable media of example 12, where the plurality of elements is arranged in a sequence of rows, and the pre-determined element is in a first row in the sequence.

Example 14 provides the one or more non-transitory computer-readable media of example 13, where the one or more other graph nodes are a group of graph nodes, and assigning the one or more other graph nodes of the plurality of graph nodes to the one or more other elements of the plurality of elements includes arranging the one or more other graph nodes into a first tier and a second tier, the first tier including one or more first graph nodes, the second tier including one or more second graph nodes, assigning the one or more first graph nodes to a second row in the sequence, and assigning the one or more second graph nodes to a third row in the sequence, where the first row precedes the second row and the third row in the sequence.

Example 15 provides the one or more non-transitory computer-readable media of example 14, where a distance from a component represented by the anchor node to a component represented by a graph node in the first tier is shorter than a distance from the component represented by the anchor node to a component represented by a graph node in the second tier, and the second row precedes the third row in the sequence.

Example 16 provides the one or more non-transitory computer-readable media of example 12, where assigning the one or more other graph nodes of the plurality of graph nodes to the one or more other elements of the plurality of elements includes determining a relationship between a graph node and the anchor node based on the graphical representation; selecting an element from the plurality of elements based on the pre-determined element and the relationship; and assigning the graph node to the element.

Example 17 provides the one or more non-transitory computer-readable media of example 16, where the graph node represents a first component of the object, the anchor node represents a second component of the object, and determining the relationship between the graph node and the anchor node includes determining the relationship based on a distance from the first component to the second component in the graphical representation.

Example 18 provides the one or more non-transitory computer-readable media of example 11, where determining a condition of the object based on the output of the neural network includes determining a pose of the object based on the output of the neural network.

Example 19 provides the one or more non-transitory computer-readable media of example 11, where the graphical representation is a two-dimensional graphical representation, and determining a condition of the object based on the output of the neural network includes generating a three-dimensional graphical representation of the object based on the output of the neural network.

Example 20 provides the one or more non-transitory computer-readable media of example 11, where the convolutional layer is configured to extract the features from the grid representation of the object by generating a first grid representation and a second grid representation based on the grid representation, the first grid representation having a different structure from the second grid representation; and generating the features based on the first grid representation and a second grid representation.

Example 21 provides an apparatus for training a target neural network, the apparatus including a computer processor for executing computer program instructions; and a non-transitory computer-readable memory storing computer program instructions executable by the computer processor to perform operations including identifying a plurality of graph nodes from a graphical representation (i.e., a 2D graphical representation) of an object, each graph node representing a component of the object, generating a grid representation of the object by arranging the plurality of graph nodes based on a grid that includes a plurality of elements, where the plurality of graph nodes is assigned to different ones of the plurality of elements of the grid, inputting the grid representation of the object into a neural network, the neural network including a convolutional layer configured to extract features from the grid representation of the object, and determining a condition of the object based on an output of the neural network.

Example 22 provides the apparatus of example 21, where generating the grid representation of the object includes selecting an anchor node from the plurality of graph nodes; assigning the anchor node to a pre-determined element of the plurality of elements; and assigning one or more other graph nodes of the plurality of graph nodes to one or more other elements of the plurality of elements.

Example 23 provides the apparatus of example 22, where assigning the one or more other graph nodes of the plurality of graph nodes to the one or more other elements of the plurality of elements includes determining a relationship between a graph node and the anchor node based on the graphical representation; selecting an element from the plurality of elements based on the pre-determined element and the relationship; and assigning the graph node to the element.

Example 24 provides the apparatus of example 21, where the graphical representation is a two-dimensional graphical representation, and determining a condition of the object based on the output of the neural network includes generating a three-dimensional graphical representation of the object based on the output of the neural network.

Example 25 provides the apparatus of example 21, where the convolutional layer is configured to extract the features from the grid representation of the object by generating a first grid representation and a second grid representation based on the grid representation, the first grid representation having a different structure from the second grid representation; and generating the features based on the first grid representation and a second grid representation.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method, the method comprising:
identifying a plurality of graph nodes from a graphical representation of an object, each graph node representing a component of the object;
generating a grid representation of the object by arranging the plurality of graph nodes based on a grid that includes a plurality of elements, wherein the plurality of graph nodes is assigned to different ones of the plurality of elements of the grid;
inputting the grid representation of the object into a neural network, the neural network comprising a convolutional layer configured to extract features from the grid representation of the object; and
determining a condition of the object based on an output of the neural network.

2. The method of claim 1, wherein generating the grid representation of the object comprises:
selecting an anchor node from the plurality of graph nodes;
assigning the anchor node to a pre-determined element of the plurality of elements; and
assigning one or more other graph nodes of the plurality of graph nodes to one or more other elements of the plurality of elements,
wherein the plurality of elements is arranged in a sequence of rows, and the pre-determined element is in a first row in the sequence.

3. (canceled)

4. The method of claim 2, wherein assigning the one or more other graph nodes of the plurality of graph nodes to the one or more other elements of the plurality of elements comprises:
arranging the one or more other graph nodes into a first tier and a second tier, the first tier including one or more first graph nodes, the second tier including one or more second graph nodes,
assigning the one or more first graph nodes to a second row in the sequence, and
assigning the one or more second graph nodes to a third row in the sequence,
wherein the first row precedes the second row and the third row in the sequence,
wherein a distance from a component represented by the anchor node to a component represented by a graph node in the first tier is shorter than a distance from the component represented by the anchor node to a component represented by a graph node in the second tier, and the second row precedes the third row in the sequence.

5. (canceled)

6. The method of claim 2, wherein assigning the one or more other graph nodes of the plurality of graph nodes to the one or more other elements of the plurality of elements comprises:
determining a relationship between a graph node and the anchor node based on the graphical representation;
selecting an element from the plurality of elements based on the pre-determined element and the relationship; and
assigning the graph node to the element,
wherein the graph node represents a first component of the object, the anchor node represents a second component of the object, and determining the relationship between the graph node and the anchor node comprises determining the relationship based on a distance from the first component to the second component in the graphical representation.

7. (canceled)

8. The method of claim 1, wherein determining a condition of the object based on the output of the neural network comprises:
determining a pose of the object based on the output of the neural network.

9. The method of claim 1, wherein the graphical representation is a two-dimensional graphical representation, and determining a condition of the object based on the output of the neural network comprises:
generating a three-dimensional graphical representation of the object based on the output of the neural network.

10. The method of claim 1, wherein the convolutional layer is configured to extract the features from the grid representation of the object by:
generating a first grid representation and a second grid representation based on the grid representation, the first grid representation having a different structure from the second grid representation; and
generating the features based on the first grid representation and a second grid representation.

11. One or more non-transitory computer-readable media storing instructions executable to perform operations for training a target neural network, the operations comprising:
identifying a plurality of graph nodes from a graphical representation (i.e., a 2D graphical representation) of an object, each graph node representing a component of the object;
generating a grid representation of the object by arranging the plurality of graph nodes based on a grid that includes a plurality of elements, wherein the plurality of graph nodes is assigned to different ones of the plurality of elements of the grid;
inputting the grid representation of the object into a neural network, the neural network comprising a convolutional layer configured to extract features from the grid representation of the object; and
determining a condition of the object based on an output of the neural network.

12. The one or more non-transitory computer-readable media of claim 11, wherein generating the grid representation of the object comprises:
selecting an anchor node from the plurality of graph nodes;
assigning the anchor node to a pre-determined element of the plurality of elements; and
assigning one or more other graph nodes of the plurality of graph nodes to one or more other elements of the plurality of elements,
wherein the plurality of elements is arranged in a sequence of rows, and the pre-determined element is in a first row in the sequence.

13. (canceled)

14. The one or more non-transitory computer-readable media of claim 12, wherein assigning the one or more other graph nodes of the plurality of graph nodes to the one or more other elements of the plurality of elements comprises:
arranging the one or more other graph nodes into a first tier and a second tier, the first tier including one or more first graph nodes, the second tier including one or more second graph nodes,
assigning the one or more first graph nodes to a second row in the sequence, and
assigning the one or more second graph nodes to a third row in the sequence,
wherein the first row precedes the second row and the third row in the sequence,
wherein a distance from a component represented by the anchor node to a component represented by a graph node in the first tier is shorter than a distance from the component represented by the anchor node to a component represented by a graph node in the second tier, and the second row precedes the third row in the sequence.

15. (canceled)

16. The one or more non-transitory computer-readable media of claim 12, wherein assigning the one or more other graph nodes of the plurality of graph nodes to the one or more other elements of the plurality of elements comprises:
determining a relationship between a graph node and the anchor node based on the graphical representation;
selecting an element from the plurality of elements based on the pre-determined element and the relationship; and
assigning the graph node to the element.

17. The one or more non-transitory computer-readable media of claim 16, wherein the graph node represents a first component of the object, the anchor node represents a second component of the object, and determining the relationship between the graph node and the anchor node comprises:
determining the relationship based on a distance from the first component to the second component in the graphical representation.

18. The one or more non-transitory computer-readable media of claim 11, wherein determining a condition of the object based on the output of the neural network comprises:
determining a pose of the object based on the output of the neural network.

19. The one or more non-transitory computer-readable media of claim 11, wherein the graphical representation is a two-dimensional graphical representation, and determining a condition of the object based on the output of the neural network comprises:
generating a three-dimensional graphical representation of the object based on the output of the neural network.

20. The one or more non-transitory computer-readable media of claim 11, wherein the convolutional layer is configured to extract the features from the grid representation of the object by:
generating a first grid representation and a second grid representation based on the grid representation, the first grid representation having a different structure from the second grid representation; and
generating the features based on the first grid representation and a second grid representation.

21. An apparatus for training a target neural network, the apparatus comprising:
a computer processor for executing computer program instructions; and
a non-transitory computer-readable memory storing computer program instructions executable by the computer processor to perform operations comprising:
identifying a plurality of graph nodes from a graphical representation (i.e., a 2D graphical representation) of an object, each graph node representing a component of the object,
generating a grid representation of the object by arranging the plurality of graph nodes based on a grid that includes a plurality of elements, wherein the plurality of graph nodes is assigned to different ones of the plurality of elements of the grid,
inputting the grid representation of the object into a neural network, the neural network comprising a convolutional layer configured to extract features from the grid representation of the object, and
determining a condition of the object based on an output of the neural network.

22. The apparatus of claim 21, wherein generating the grid representation of the object comprises:
selecting an anchor node from the plurality of graph nodes;
assigning the anchor node to a pre-determined element of the plurality of elements; and
assigning one or more other graph nodes of the plurality of graph nodes to one or more other elements of the plurality of elements.

23. The apparatus of claim 22, wherein assigning the one or more other graph nodes of the plurality of graph nodes to the one or more other elements of the plurality of elements comprises:
determining a relationship between a graph node and the anchor node based on the graphical representation;
selecting an element from the plurality of elements based on the pre-determined element and the relationship; and
assigning the graph node to the element.

24. The apparatus of claim 21, wherein the graphical representation is a two-dimensional graphical representation, and determining a condition of the object based on the output of the neural network comprises:
generating a three-dimensional graphical representation of the object based on the output of the neural network.

25. The apparatus of claim 21, wherein the convolutional layer is configured to extract the features from the grid representation of the object by:
generating a first grid representation and a second grid representation based on the grid representation, the first grid representation having a different structure from the second grid representation; and
generating the features based on the first grid representation and a second grid representation.
